(19) United States
(12) Patent Application Publication
(10) Pub. No.: US 2006/0077802 A1
(43) Pub. Date: Apr. 13, 2006

(54) Optical disk device

(76) Inventors: Hiroshi Koshida, Osaka (JP); Masanori Harui, Osaka (JP); Yasuo Nakata, Osaka (JP); Yoshimitsu Saka, Osaka (JP); Koju Konno, Osaka (JP); Masamichi Katada, Osaka (JP)

Correspondence Address: MCDERMOTT WILL & EMERY LLP, 600 13TH STREET, N.W., WASHINGTON, DC, 20005-3096, US

(21) Appl. No.: 11/203,183

(22) Filed: Aug. 15, 2005

(30) Foreign Application Priority Data
Sep. 15, 2004 (JP) 2004-268231

(51) Int. Cl. G11B 7/00

(52) U.S. Cl. 369/44.27; 369/44.28; 369/44.37

(57) ABSTRACT

In an optical disk device, an output terminal is connected to an optical pickup, and a preceding sub-beam returning light signal which is electrical signal obtained by converting returning light of a sub-beam preceding an main beam is output through the output terminal. A defect period detection circuit detects a defect period during which a beam is passing through a defective portion on an optical disk based on the preceding sub-beam returning light signal from the output terminal. A servo hold circuit holds tracking servo during the detected defect period. Therefore, even when an amplitude of an RF signal is quickly attenuated during the defect period, the defect period is detected at an early stage of the attenuation, thereby suppressing a change in an amplitude of a tracking error signal to a small level.

### CROSS REFERENCE TO RELATED APPLICATIONS

This Non-provisional application claims priority under 35 U.S.C. §119(a) on Patent Application No. 2004-268231 filed in Japan on Sep. 15, 2004, the entire contents of which are hereby incorporated by reference.

### BACKGROUND OF THE INVENTION

The present invention relates to a three-beam optical disk device for reproducing and outputting information recorded on an optical disk.

Generally, optical disk devices for reproducing information from an optical disk, such as a CD (Compact Disk), a DVD (Digital Versatile Disk) or the like, essentially require tracking control (tracking servo) for causing a reading beam spot of an optical pickup to follow a track having a sequence of pits on the optical disk. The tracking servo is performed based on a tracking error signal which is generated from a signal carried on returning light (reflected light) from the optical disk, the signal being detected by the optical pickup.

However, there may be a scratch or foreign matter on an optical disk surface or a recorded pit may be damaged (these cases are referred to as defects). When a beam enters such a defective portion, the tracking error signal may be disturbed due to the defect. In this case, beam tracking is altered, so that tracking may be disturbed or deviated when the beam exits the defective portion.

For example, as disclosed in Japanese Unexamined Patent Publication No. S61-96529, a defect period (a period of time during which a beam passes through a defective portion) is detected, and, a tracking error signal is muted during the defect period (i.e., fixed to an appropriate intermediate level), or alternatively, the tracking error signal is fixed to a level thereof immediately before the defect period, thereby making it possible to suppress disturbance of the tracking error signal during the defect period. Thereby, it is possible to reduce occurrence of tracking deviation which is otherwise caused by a defect.

Hereinafter, a conventional optical disk device will be described with reference to FIG. 14.

FIG. 14 illustrates a structure of a conventional three-beam optical disk device which reproduces and outputs information recorded on an optical disk.

In FIG. 14, reference numeral 1 indicates an optical pickup. The optical pickup 1 comprises a main beam sensor for detecting returning light (reflected light) of a main beam, the main beam sensor being divided into four sections, and two sub-beam sensors for detecting returning light of two sub-beams for the purpose of tracking servo, the two sub-beam sensors being respectively provided before and after the main beam sensor and on right and left sides of a pit scanning direction. Four electrical signals obtained by conversion by the main beam sensor are referred to as A to D signals. A sub-beam which precedes a main beam is referred to as a preceding sub-beam. A sub-beam which follows the main beam is referred to as a following sub-beam. A sub-beam sensor which detects returning light of the preceding sub-beam is referred to as a sub-beam sensor E. A sub-beam sensor for detecting returning light of the following sub-beam is referred to as a sub-beam sensor F. A signal detected by the sub-beam sensor E is referred to as an E signal. A signal detected by the sub-beam sensor F is referred to as an F signal.

In FIG. 14, reference numerals 2 and 3 indicate first and second output terminals connected to the optical pickup 1. The E signal is output to the first output terminal 2, and the F signal is output to the second output terminal 3.

Reference numeral 4 indicates a tracking error signal generation circuit which is connected to the first and second output terminals, and generates a tracking error signal (hereinafter referred to as a TE signal) by calculating a subtraction (a value of the E signal minus a value of the F signal). Reference numeral 6 indicates a tracking control circuit for performing tracking servo using the TE signal.

Reference numeral 9 indicates a third output terminal which is connected to the optical pickup 1 and through which a signal (RF signal (digitally modulated signal)) obtained by summing the four A to D signals from the main beam sensor are output. Reference numeral 10 indicates an AGC circuit which is connected to the third output terminal 9 and normalizes the RF signal to a predetermined amplitude. Reference numeral 11 indicates a focus control circuit which generates a focusing error signal based on the RF signal from the third output terminal 9 to perform focusing servo.

The tracking control circuit 6 controls a driver amplifier (not illustrated) for a tracking actuator of the optical pickup 1 based on the TE signal from the tracking error signal generation circuit 4. Thereby, the RF signal is produced from information recorded on an optical disk 8 while performing tracking servo, and meanwhile, the information recorded on an optical disk 8 is reproduced based on the normalized RF signal from the AGC circuit 10 while focusing servo is performed by the focus control circuit 11.

Further, in FIG. 14, reference numeral 40 indicates a defect period detection circuit which detects a defect period based on the normalized RF signal from the AGC circuit 10 and outputs a defect period signal. Reference numeral 7 indicates a servo hold circuit which is contained in the tracking control circuit 6 and holds the TE signal to a value (level) immediately before the defect period based on the defect period signal detected by the defect period detection circuit 40. Reference numeral 39 indicates an AGC hold circuit which receives the defect period signal from the defect period detection circuit 40 and holds a gain of the AGC circuit 10 to a fixed value during the defect period.

FIG. 15 illustrates a positional relationship between a main beam, sub-beams, and a defective portion on a surface of an optical disk. In FIG. 15, a preceding sub-beam 45, a main beam 44, and a following sub-beam 46 are arranged in this order in a rotating direction of an optical disk. It is assumed that a defective portion 47 is present. In this case, in the optical disk device of FIG. 14, detection of a defect period is performed by the defect period detection circuit 40 based on a level of the RF signal which is transferred from the optical pickup 1 via the third output terminal 9 to the AGC circuit 10 and is then normalized by the AGC circuit 10. Therefore, there is some time lag between the time when the preceding sub-beam enters the defective portion to the time when a defect period is detected based on a reduced level of the RF signal. When a defect, such as a scratch on a surface of an optical disk or foreign matter attached thereon, is present on the optical disk surface, an amplitude of an RF signal which is obtained in a defective portion is attenuated sufficiently slowly (it takes a sufficiently long time) as compared to a time difference between the start of a change in the E signal and the start of a change in the F signal. Therefore, the TE signal has a small amplitude a when servo is held. The TE signal also has a small variation width b immediately after hold of servo is released, and therefore, disturbance of tracking due to the defect is small and negligible.

According to a study by the present inventors, however, when a defect, such as one which occurs during a manufacturing process of an optical disk, is present on a recording surface, the amplitude of an RF signal in the defect is attenuated as quickly as the time difference between the start of a change in the E signal and the start of a change in the F signal as illustrated in FIG. 17. Therefore, in the conventional optical disk device, when a defect period is detected based on the level of the RF signal by the defect period detection circuit 40, an amplitude A of the TE signal when tracking servo is held is large, and a variation width B of the TE signal immediately after hold of tracking servo is released is large. As a result, disturbance of tracking control due to the defect is increased. If the disturbance is excessively large, servo is out of control.

### SUMMARY OF THE INVENTION

An object of the present invention is to provide an optical disk device capable of suppress disturbance of a TE signal due to a defect present on a recording surface of an optical disk as much as possible to effectively suppress occurrence of disturbance of tracking control due to the defect.

The object of the present invention is achieved as follows. It is assumed that a beam enters a defective portion present on a recording surface of an optical disk. In this case, even if an amplitude of a RF signal is quickly attenuated, a defect period is detected at an early stage of the attenuation based on an E signal generated from returning light of a sub-beam preceding a main beam, but not based on the RF signal generated from returning light of the main beam.

Specifically, an optical disk device of the present invention comprises an optical pickup of outputting a main beam and sub-beams preceding and following the main beam onto an optical disk. In order to reproduce information recorded on the optical disk, a digitally modulated signal and a focusing error signal are detected based on a reading spot of the main beam of the optical pickup, and a tracking error signal is detected based on reading spots of the preceding and following sub-beams of the optical pickup. The optical disk device further comprises a tracking error signal generation circuit connected to a first output terminal through which a preceding sub-beam returning light signal is obtained, the preceding sub-beam returning light signal being an electrical signal obtained by converting returning light of the preceding sub-beam of the optical pickup, and a second output terminal through which a following sub-beam returning light signal is obtained, the following sub-beam returning light signal being an electrical signal obtained by converting returning light of the following sub-beam of the optical pickup, wherein the tracking error signal generation circuit generates the tracking error signal based on the preceding and following sub-beam returning light signals from the first and second output terminals, a tracking control circuit of receiving the tracking error signal of the tracking error signal generation circuit and performing tracking control based on the tracking error signal, a defect period detection circuit of detecting a defect period of the optical disk and outputting a defect period signal, based on the preceding sub-beam returning light signal from the first output terminal or the preceding and following sub-beam returning light signals from both the first and second output terminals, and a hold circuit of receiving the defect period signal of the defect period detection circuit and holding the tracking control by the tracking control circuit based on the defect period signal.

In an example of the present invention, in the optical disk device, the defect period detection circuit comprises a first reference level generation circuit of receiving the preceding sub-beam returning light signal of the first output terminal and generating a first reference level based on a dark level of the preceding sub-beam returning light signal, a second reference level generation circuit of receiving the preceding sub-beam returning light signal of the first output terminal and generating a second reference level using a lower level of an RF component of the preceding sub-beam returning light signal, a third reference level generation circuit of generating a third reference level having a value between the first and second reference levels generated in the first and second reference level generation circuits, a first pulse generation circuit of receiving the preceding sub-beam returning light signal of the first output terminal and binarizing the preceding sub-beam returning light signal with reference to the third reference level of the third reference level generation circuit to generate a first pulse, and a monostable circuit of extending a rear edge of the first pulse generated by the first pulse generation circuit by a predetermined time to generate the defect period signal.

In an example of the present invention, in the optical disk device, the defect period detection circuit comprises a bottom hold circuit of bottom-holding the preceding sub-beam returning light signal, provided on a pathway through which the preceding sub-beam returning light signal is input from the first output terminal to the first pulse generation circuit.

In an example of the present invention, in the optical disk device, the defect period detection circuit comprises a normalization level adjustment circuit of adjusting one or both of the preceding sub-beam returning light signal and the third reference level, provided on at least one of a pathway through which the preceding sub-beam returning light signal is input from the first output terminal to the first pulse generation circuit and a pathway through which the third reference level of the third reference level generation circuit is input to the first pulse generation circuit.

In an example of the present invention, in the optical disk device, the defect period detection circuit comprises a first reference level generation circuit of receiving the preceding sub-beam returning light signal of the first output terminal and generating a first reference level based on a dark level of the preceding sub-beam returning light signal, a second reference level generation circuit of receiving the preceding sub-beam returning light signal of the first output terminal and using a lower level of an RF component of the preceding sub-beam returning light signal to generate a second reference level, a third reference level generation circuit of generating a third reference level having a value between the first and second reference levels generated in the first and second reference level generation circuits, a first pulse generation circuit of receiving the preceding sub-beam returning light signal from the first output terminal and binarizing the preceding sub-beam returning light signal with reference to the third reference level of the third reference level generation circuit to generate a first pulse, a fourth reference level generation circuit of receiving the following sub-beam returning light signal of the second output terminal and generating a fourth reference level based on a dark level of the following sub-beam returning light signal, a fifth reference level generation circuit of receiving the following sub-beam returning light signal of the second output terminal and using a lower level of an RF component of the following sub-beam returning light signal to generate a fifth reference level, a sixth reference level generation circuit of generating a sixth reference level having a value between the fourth and fifth reference levels generated in the fourth and fifth reference level generation circuits, a second pulse generation circuit of receiving the following sub-beam returning light signal of the second output terminal and binarizing the following sub-beam returning light signal with reference to the sixth reference level of the sixth reference level generation circuit to generate a second pulse, and a first OR circuit of receiving the first and second pulses from the first and second pulse generation circuits and calculating a logical OR of the first and second pulses.

In an example of the present invention, in the optical disk device, the defect period detection circuit comprises a first reference level generation circuit of receiving the preceding sub-beam returning light signal of the first output terminal and generating a first reference level based on a dark level of the preceding sub-beam returning light signal, a second reference level generation circuit of receiving the preceding sub-beam returning light signal of the first output terminal and using a lower level of an RF component of the preceding sub-beam returning light signal to generate a second reference level, a third reference level generation circuit of generating a third reference level having a value between the first and second reference levels generated in the first and second reference level generation circuits, a fourth reference level generation circuit of receiving the following sub-beam returning light signal of the second output terminal and generating a fourth reference level based on a dark level of the following sub-beam returning light signal, a fifth reference level generation circuit of receiving the following sub-beam returning light signal of the second output terminal and using a lower level of an RF component of the following sub-beam returning light signal to generate a fifth reference level, a sixth reference level generation circuit of generating a sixth reference level having a value between the fourth and fifth reference levels generated in the fourth and fifth reference level generation circuits, a first bottom hold circuit of outputting a lower envelope of the preceding sub-beam returning light signal of the first output terminal, a first peak hold circuit of outputting an upper envelope of the preceding sub-beam returning light signal of the first output terminal, a second bottom hold circuit of outputting a lower envelope of the following sub-beam returning light signal of the second output terminal, a second peak hold circuit of outputting an upper envelope of the following sub-beam returning light signal of the second output terminal, a first pulse generation circuit of binarizing the output signal of the first bottom hold circuit based on the third reference level of the third reference level generation circuit to generate a first pulse, a second pulse generation circuit of binarizing the output signal of the second bottom hold circuit based on the sixth reference level of the sixth reference level generation circuit to generate a second pulse, a third pulse generation circuit of binarizing the output signal of the first peak hold circuit based on the third reference level of the third reference level generation circuit to generate a third pulse, a fourth pulse generation circuit of binarizing the output signal of the second peak hold circuit based on the sixth reference level of the sixth reference level generation circuit to generate a fourth pulse, a first droop rate changing circuit of increasing a droop rate of the first peak hold circuit using rising of the first pulse of the first pulse generation circuit and decreasing the droop rate using falling of the third pulse of the third pulse generation circuit, a second droop rate changing circuit of increasing a droop rate of the second peak hold circuit using rising of the second pulse of the second pulse generation circuit and decreasing the droop rate using falling of the fourth pulse of the fourth pulse generation circuit, a first OR circuit of receiving the first and third pulses from the first and third pulse generation circuits and calculating a logical OR of the first and third pulses, a second OR circuit of receiving the second and fourth pulses from the second and fourth pulse generation circuits and calculating a logical OR of the second and fourth pulses from the second and fourth pulses, and a fifth pulse generation circuit of generating a pulse indicating a start of a defect period with rising of an output signal of the first OR circuit and a pulse indicating an exit from the defect period with falling of an output signal of the second OR circuit.

In an example of the present invention, the optical disk device comprises an AGC circuit connected to a third output terminal through which a main beam returning light signal is obtained, the main beam returning light signal being an electrical signal obtained by converting returning light of the main beam of the optical pickup, wherein the AGC circuit generates an RF signal obtained by normalizing an amplitude of the main beam returning light signal to a predetermined value, a second defect period detection circuit of generating a second defect period signal indicating a second defect detection period in which detection of entry into a defect period is later and detection of exit from the defect period is earlier than those of the defect period signal generated by the defect period detection circuit, and an AGC hold circuit of fixing a gain of the AGC circuit to a predetermined value during the second defect detection period indicated by the second defect period signal of the second defect period detection circuit.

In an example of the present invention, in the optical disk device, the second defect period detection circuit receives the RF signal from the AGC circuit and generates the second defect period signal based on the RF signal.

Another optical disk device of the present invention comprises an optical pickup of outputting a main beam and sub-beams preceding and following the main beam onto an optical disk. In order to reproduce information recorded on the optical disk, a digitally modulated signal and a focusing error signal are detected based on a reading spot of the main beam of the optical pickup, and a tracking error signal is detected based on reading spots of the preceding and following sub-beams of the optical pickup. The optical disk device further comprises a tracking error signal generation circuit connected to a first output terminal through which a preceding sub-beam returning light signal is obtained, the preceding sub-beam returning light signal being an electrical signal obtained by converting returning light of the preceding sub-beam of the optical pickup, and a second output terminal through which a following sub-beam returning light signal is obtained, the following sub-beam returning light signal being an electrical signal obtained by converting returning light of the following sub-beam of the optical pickup, wherein the tracking error signal generation circuit generates the tracking error signal based on the preceding and following sub-beam returning light signals from the first and second output terminals, a tracking control circuit of receiving the tracking error signal of the tracking error signal generation circuit and performing tracking control based on the tracking error signal, a defect period detection circuit of detecting a defect period of the optical disk and outputting a first defect period signal, and a second defect period signal indicating a second defect detection period in which detection of entry into a defect period is later and detection of exit from the defect period is earlier than those of the first defect period signal, based on the preceding sub-beam returning light signal from the first output terminal or the preceding and following sub-beam returning light signals from both the first and second output terminals, a hold circuit of receiving the first defect period signal of the defect period detection circuit and holding the tracking control by the tracking control circuit based on the first defect period signal, an AGC circuit connected to a third output terminal through which a main beam returning light signal is obtained, the main beam returning light signal being an electrical signal obtained by converting returning light of the main beam of the optical pickup, wherein the AGC circuit generates an RF signal obtained by normalizing an amplitude of the main beam returning light signal to a predetermined value, and an AGC hold circuit of fixing a gain of the AGC circuit to a predetermined value during the second defect detection period indicated by the second defect period signal of the defect period detection circuit.

Thus, in the optical disk device of the present invention, the preceding sub-beam returning light signal is used to detect a defect period. Thereby, it is possible to detect a defect period more quickly by a time difference between the main beam and the preceding sub-beam than when the main beam returning light signal is conventionally used for detection. Therefore, an amplitude of the TE signal when servo is held can be suppressed to a small level, resulting in less disturbance of tracking control.

In an example of the present invention, the defect period detection circuit can detect, as a defect period, a period of time from a time when a preceding sub-beam enters a defective portion so that the preceding sub-beam returning light signal becomes lower than or equal to the third reference level to a time when the preceding sub-beam returning light signal becomes higher than the third reference level and a predetermined time is then elapsed (e.g., a time difference in the start of a change between the preceding sub-beam returning light signal and the following sub-beam returning light signal).

In an example of the present invention, in the defect period detection circuit, the preceding sub-beam returning light signal is bottom-held by the bottom hold circuit before binarization of the preceding sub-beam returning light signal, thereby preventing chattering which otherwise occurs in binarization of the preceding sub-beam returning light signal.

In an example of the present invention, in the defect period detection circuit, the level of one or both of the preceding sub-beam returning light signal and the third reference level is adjusted by the normalization level adjustment circuit in binarization of the preceding sub-beam returning light signal. Therefore, even when an optical disk in which the lower level of the RF component of the preceding sub-beam returning light signal varies significantly is used, it is possible to adjust the sensitivity of detection of a defect period so that erroneous detection of the defect period less occurs, resulting in stable detection of the defect period.

In an example of the present invention, a period of time from a time when one of the preceding sub-beam and the following sub-beam enters a defective portion until a time when both the preceding sub-beam and the following sub-beam exit from the defective portion, is detected as a defect period. Therefore, it is possible to correctly detect a defect period of even a defective portion whose border is oblique with respect to a radial direction of an optical disk.

In an example of the present invention, in addition to the above-described structure of the optical disk device, the preceding sub-beam returning light signal and the following sub-beam returning light signal are bottom-held by the first and second bottom hold circuit before binarization of the preceding and following sub-beam returning light signals, thereby preventing chattering which otherwise occurs in binarization of each of the preceding and following sub-beam returning light signals.

In an example of the present invention, as compared to a defect period detected by the defect period detection circuit, a second defect period detected by the second defect period detection circuit has later entry into the defect period and earlier exit from the defect period. Therefore, the AGC circuit holds normalization of the amplitude of the RF signal only during the short second defect period, resulting in less failure of data detection.

In an example of the present invention, the second defect period detection circuit generates the second defect period signal based on the RF signal from the AGC circuit, resulting in less disturbance of tracking control. In addition, hold of the gain of the AGC circuit can be delayed as long as the amplitude of the RF signal of the AGC circuit can be normalized, resulting in less failure of data detection.

In the optical disk device of the present invention, a single defect period detection circuit is used to generate first and second defect period signals having different sensitivities based on the preceding sub-beam returning light signal, resulting in a simpler circuit structure and thus low manufacturing cost.

### BRIEF DESCRIPTION OF THE DRAWINGS

FIG. 1 is a diagram illustrating an optical disk device according to a first embodiment of the present invention.

FIG. 2 is a diagram illustrating a defect period detection circuit in the optical disk device of FIG. 1.

FIG. 3 is a diagram illustrating waveforms of major parts of the defect period detection circuit of FIG. 2 when a beam passes through a defective portion present on an optical disk.

FIG. 4 is a diagram illustrating an optical disk device according to a second embodiment of the present invention.

FIG. 5 is a diagram illustrating a defect period detection circuit in the optical disk device of FIG. 4.

FIG. 6 is a diagram illustrating waveforms of major parts of the defect period detection circuit of FIG. 5 when a beam passes through a defective portion present on an optical disk.

FIG. 7 is a diagram illustrating a defect period detection circuit in an optical disk device according to the third embodiment of the present invention.

FIG. 8 is a diagram illustrating waveforms of major parts of the defect period detection circuit of FIG. 7 when a beam passes through a defective portion present on an optical disk. (a) of FIG. 8 illustrates various signals obtained using a preceding sub-beam, (b) of FIG. 8 illustrates various signals obtained using a following sub-beam, and (c) of FIG. 8 illustrates various signals of the defect period detection circuit of FIG. 7.

FIG. 9 is a diagram illustrating an optical disk device according to a fourth embodiment of the present invention.

FIG. 10 is a diagram illustrating waveforms of major parts of the optical disk device of FIG. 9 when a beam passes through a defective portion present on an optical disk.

FIG. 11 is a diagram illustrating an optical disk device according to a fifth embodiment of the present invention.

FIG. 12 is a diagram illustrating a defect period detection circuit in the optical disk device of FIG. 11.

FIG. 13 is a diagram illustrating waveforms of major parts of the defect period detection circuit of FIG. 12 when a beam passes through a defective portion present on an optical disk.

FIG. 14 is a diagram illustrating a conventional optical disk device.

FIG. 15 is a diagram illustrating a positional relationship between a main beam, sub-beams, and a defective portion on a surface of an optical disk.

FIG. 16 is a diagram illustrating waveforms of major parts of a conventional optical disk device when a beam passes through an ordinary defective portion.

FIG. 17 is a diagram illustrating waveforms of major parts of a conventional optical disk device when a beam passes through a defective portion present on an optical disk.

### DESCRIPTION OF THE PREFERRED EMBODIMENTS

Hereinafter, preferable embodiments of the present invention will be described with reference to the accompanying drawings.

### First Embodiment

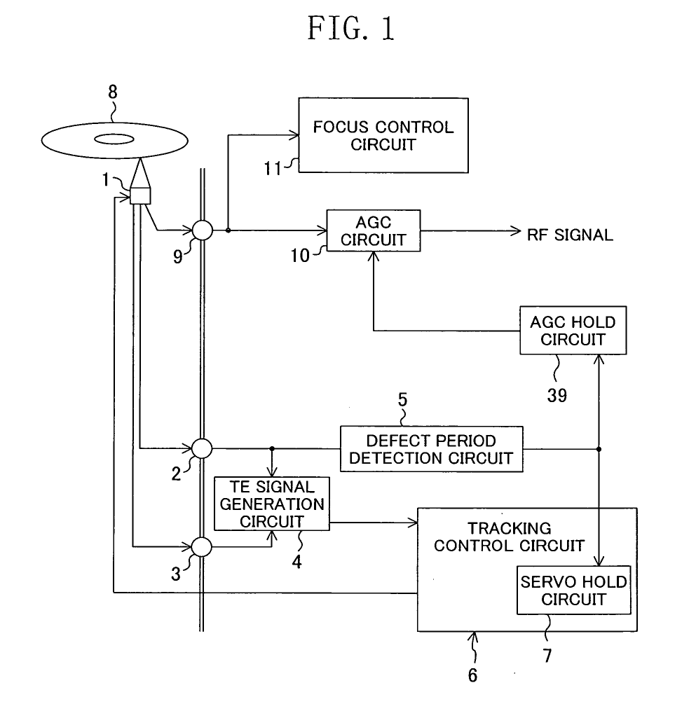

FIG. 1 illustrates an optical disk device according to a first embodiment of the present invention.

In the optical disk device of FIG. 1, reference numeral 1 indicates an optical pickup; 8 indicates an optical disk; 2 indicates a first output terminal which receives returning light of a preceding sub-beam; 3 indicates a second output terminal which receives returning light of a following sub-beam; 9 indicates a third output terminal which receives returning light of a main beam; 4 indicates a TE signal generation circuit (tracking error signal generation circuit); 6 indicates a tracking control circuit; 7 indicates a servo hold circuit (hold circuit); 10 indicates an AGC circuit; 11 indicates a focus control circuit; and 39 indicates an AGC hold circuit. These components are the same as those of the above-described optical disk device of FIG. 14 and will not be explained in detail.

The present invention is different from the conventional example of FIG. 14 in that the defect period detection circuit 5 is connected to the first output terminal 2 through which the E signal is output, but not to an output of the AGC circuit 10. Thereby, it is possible to use the E signal which enters a defect period earlier than a main beam so as to detect the defect period. As a result, an amplitude of the TE signal when tracking servo is held can be suppressed to a small level, thereby making it possible to provide an optical disk device having less disturbance of tracking control.

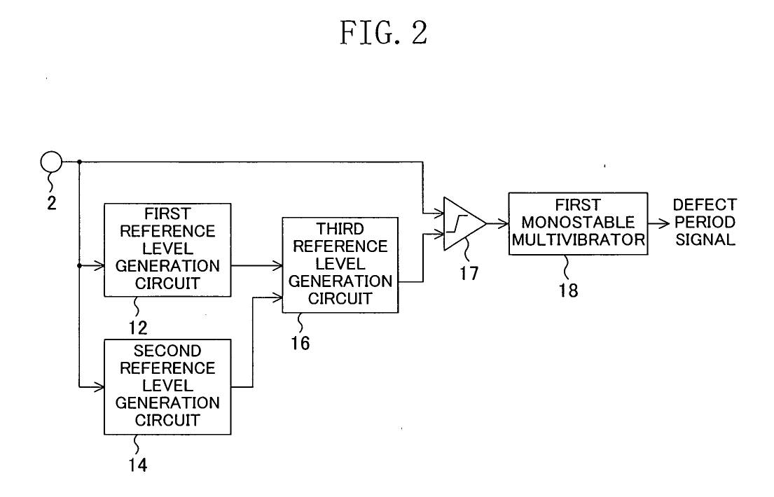

Next, a structure of the defect period detection circuit in the optical disk device according to the first embodiment of the present invention will be described with reference to FIG. 2.

A first reference level generation circuit 12 is connected to the first output terminal 2 and generates a first reference level based on a dark level of the E signal. A second reference level generation circuit 14 is connected to the first output terminal 2 and bottom-holds the E signal to generate a second reference level based on a lower level of an RF component of the E signal.

In the first embodiment, bottom hold is used as a method of generating the second reference level. Instead of bottom hold, the lower level of the RF component of the E signal may be obtained based on an average level of the E signal and ½ of an amplitude of the RF component of the E signal. Alternatively, the lower level of the RF component of the E signal may be obtained based on a peak hold level of the E signal and the amplitude of the RF component of the E signal.

Next, a third reference level generation circuit 16 is connected to an output of the first reference level generation circuit 12 and an output of the second reference level generation circuit 14, and outputs a third reference level which is a fixed value between the first reference level and the second reference level. A first pulse generation circuit 17 is connected to an output of the first output terminal 2 and an output of the third reference level generation circuit 16, and binarizes the E signal using the third reference level. Thereby, a first pulse indicating from the entry of the E signal into a defect period until the exit thereof from the defect period is generated.

Note that, in the first embodiment, a bottom hold circuit may be provided between the first output terminal 2 and the first pulse generation circuit 17. Thereby, it is possible to effectively suppress chattering which may otherwise occur when the E signal is binarized, resulting in stable detection of a defect period. In addition, the first pulse generation circuit 17 may be a pulse generation circuit with hysteresis.

In the first embodiment, the third reference level is assumed to be a fixed value. If the third reference level is set to be a fixed value close to the lower level of the RF component of the E signal, an erroneous detection may occur in an optical disk in which the lower level of the RF component of the E signal varies largely when the lower level of the RF component of the E signal varies after the third reference level is determined. To prevent this, a normalization level adjustment circuit may be provided on an input of the first pulse generation circuit 17 to adjust either or both of the E signal and the third reference level. In this case, the detection sensitivity of detection of a defect period can be adjusted. Therefore, the detection sensitivity can be adjusted so that an erroneous detection is avoided when the lower level of the RF component of the E signal varies, thereby making it possible to stably detect a defect period.

Next, in FIG. 2, a monostable multivibrator (monostable circuit) 18, which is connected to an output of the first pulse generation circuit 17, is used to extend the rear edge of the first pulse of the first pulse generation circuit 17 by no less than a time ((a distance between a spot of a preceding sub-beam and a spot of a following sub-beam on an optical disk)/a rotational speed of a disk). As a result, a defect period signal indicating a defect period is generated.

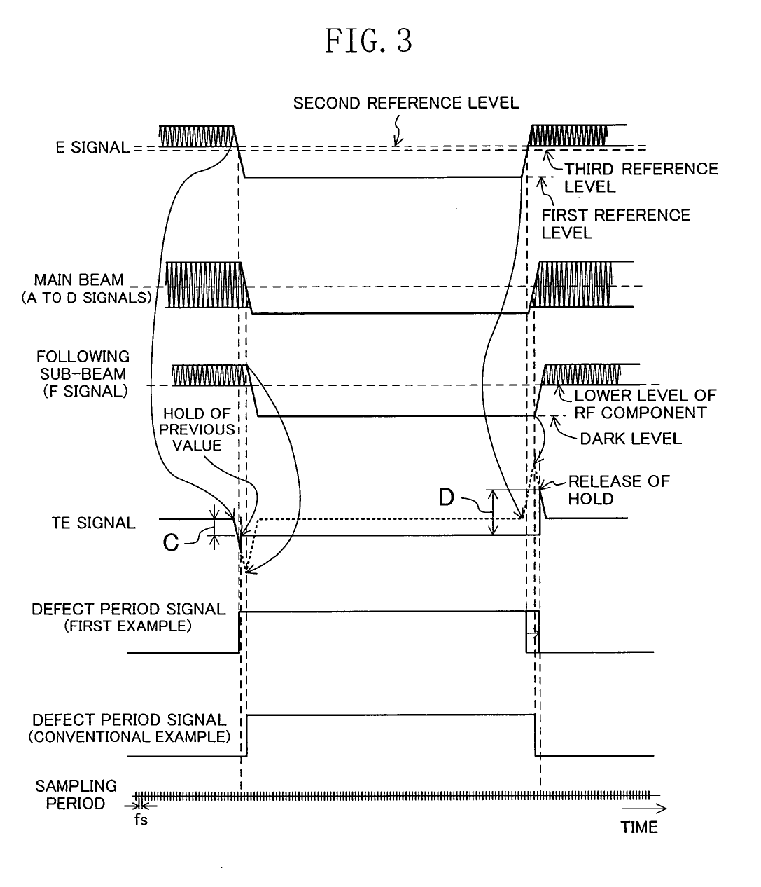

Waveforms of major parts in the thus-constructed defect period detection circuit 5 when a beam passes through a defect present on the optical disk 8 will be described with reference to FIG. 3.

FIG. 3 indicates an E signal caused by a preceding sub-beam, A to D signals caused by a main beam, an F signal caused by a following sub-beam, a TE signal, a defect period signal of the first embodiment, a defect period signal of a conventional example, and a sampling period, in this order from the top. Regarding the TE signal, a dotted line represents a waveform when hold is not performed, and a solid line represents a waveform when hold is performed.

When the preceding sub-beam enters a defective portion present on a recording surface of the optical disk 8, the E signal first starts being attenuated. When the E signal starts being attenuated, an amplitude of the TE signal starts being increased. At a time when a level of the E signal becomes lower than the third reference level, a defect period is detected, and the TE signal is held to a value in the previous sampling time (the previous value). Therefore, for example, when a time difference between the preceding sub-beam and the main beam is two times larger than the sampling period, a defect period can be detected earlier by two sampling operations in the first embodiment than in the conventional technique for detecting a defect period using a main beam. Therefore, an amplitude C of the TE signal which is held is small, whereby tracking servo is suppressed from falling into an extraordinary operation during a defect period.

When the TE signal is not held, the TE signal does not become stable until the following sub-beam exits a defective portion. Therefore, when a defect period is detected using only the E signal, the return of hold of the TE signal is advanced by a time difference between the E signal and the F signal. In the defect period detection circuit 5 of the first embodiment, the rear edge of the defect period signal detected using only the E signal is extended by a predetermined period, for example, a time difference between the E signal and the F signal. Therefore, the TE signal can be held longer until the F signal exits a defect period.

### Second Embodiment

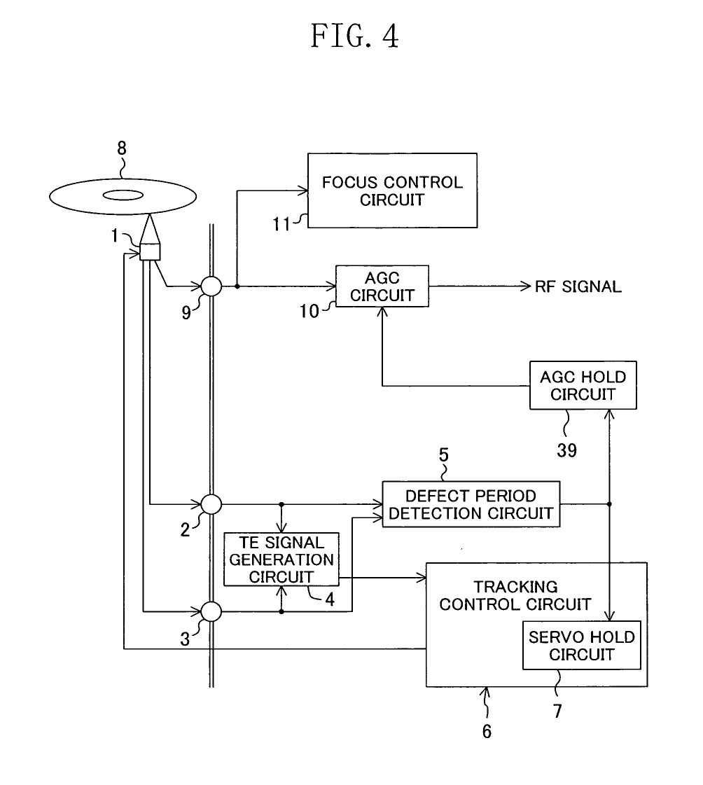

FIG. 4 illustrates an optical disk device according to a second embodiment of the present invention. The same parts as those of FIG. 1 are indicated with the same reference numerals and will not be explained.

The optical disk device of the second embodiment is different from that of the first embodiment of FIG. 1 in that the defect period detection circuit 5 is connected not only to the first output terminal 2 through which the E signal is output, but also to the second output terminal 3 through which the F signal is output, for the purpose of detection of a defect period. Thereby, a defect period can be detected using the E signal which enters the defect period earlier than the main beam and the F signal which exits the defect period later than the main beam. As a result, an amplitude of the TE signal when tracking servo is held can be suppressed to a small value, and in addition, the exit from a defect period can be correctly detected. Thus, an optical disk device having less disturbance of tracking control than that of the first embodiment can be provided.

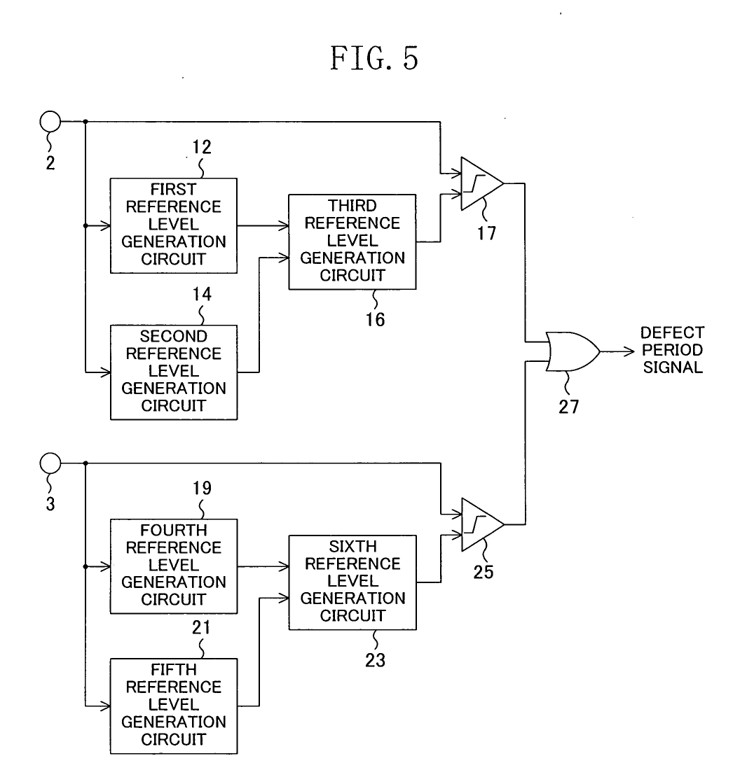

Next, a structure of the defect period detection circuit 5 in the optical disk device of the second embodiment will be described with reference to FIG. 5. Note that the same parts as those of FIG. 2 are indicated with the same reference numerals and will not be explained. The first reference level generation circuit 12 is connected to the first output terminal 2. The first reference level generation circuit 12 generates a first reference level based on a dark level of the E signal. A fourth reference level generation circuit 19 is connected to the second output terminal 3. The fourth reference level generation circuit 19 generates a fourth reference level based on a dark level of the F signal. The second reference level generation circuit 14 connected to the first output terminal 2 bottom-holds the E signal, and based on a lower level of an RF component of the E signal, generates a second reference level. A fifth reference level generation circuit 21 is connected to the second output terminal 3 and bottom-holds the F signal, and based on a lower level of an RF component of the F signal, generates a fifth reference level.

Although, in the second embodiment, bottom hold is used to generate the second and fifth reference levels, the lower levels of the RF components of the E signal and the F signal may be calculated based on average levels of the E signal and the F signal and ½ of amplitudes of the RF components of the E signal and the F signal, respectively, instead of bottom hold. Alternatively, the lower levels of the RF components of the E signal and the F signal may be calculated based on peak hold levels of the E signal and the F signal and the amplitudes of the RF components of the E signal and the F signal.

Next, the third reference level generation circuit 16 connected to an output of the first reference level generation circuit 12 and an output of the second reference level generation circuit 14 generates a third reference level which is a fixed value between the first reference level and the second reference level. The first pulse generation circuit 17 connected to the first output terminal 2 and an output of the third reference level generation circuit 16 binarizes the E signal using the third reference level. Thereby, a first pulse indicating from the entry of the E signal into a defect period until the exit thereof from the defect period is generated.

Similarly, a sixth reference level generation circuit 23 is connected to an output of the fourth reference level generation circuit 19 and an output of the fifth reference level generation circuit 21 and generates a sixth reference level which is a fixed value between the fourth reference level and the fifth reference level. A second pulse generation circuit 25 is connected to the second output terminal 3 and an output of the sixth reference level generation circuit 23 and binarizes the F signal using the sixth reference level. Thereby, a second pulse indicating from the entry of the F signal into a defect period until the exit thereof from the defect period is generated.

Note that, in the second embodiment, the E signal and the F signal are directly binarized, likely leading to occurrence of chattering. Therefore, as in the first embodiment, a bottom hold circuit may be provided between the first output terminal 2 and the first pulse generation circuit 17 and between the second output terminal 3 and the second pulse generation circuit 25. Further, the first pulse generation circuit 17 and the second pulse generation circuit 25 may each be a pulse generation circuit with hysteresis.

In the second embodiment, the third and sixth reference levels are fixed values. Therefore, if the third reference level is set to be a fixed value close to the lower level of the RF component of the E signal or the sixth reference level is set to be a fixed value close to the lower level of the RF component of the F signal, an erroneous detection occurs in an optical disk in which the lower level of the RF component of the E signal or the F signal varies significantly, when the lower level of the RF component of the E signal or the F signal varies after the third and sixth reference levels are determined. Therefore, in order to address this situation, as in the first embodiment, a first normalization level adjustment circuit (not illustrated) may be provided at an input of the first pulse generation circuit 17 to adjust one or both of the E signal and the third reference level, or alternatively, a second normalization level adjustment circuit (not illustrated) may be provided at an input of the second pulse generation circuit 25 to adjust one or both of the F signal and the sixth reference level.

Although, in the second embodiment, the binary reference level of the E signal and the binary reference level of the F signal are separately provided, either the third reference level or the sixth reference level may be used as a common reference for binarization of the E signal and the F signal.

Further, in FIG. 5, an output of the first pulse generation circuit 17 and an output of the second pulse generation circuit 25 are input to a first OR circuit 27. The first OR circuit 27 calculates a logical OR of the first pulse indicating the entry of the E signal into a defect period until the exit thereof from the defect period and the second pulse indicating from the entry of the F signal into a defect period until the exit thereof from the defect period. Therefore, with an output of the first OR circuit 27, it is possible to correctly detect a period of time from the entry of one of a preceding sub-beam and a following sub-beam into a defective portion until the exit of both of the preceding sub-beam and the following sub-beam from the defective portion as a defect period even when the defective portion has a shape such that a border of the defective portion is oblique with respect to a radial direction of the optical disk 8.

Note that, in the second embodiment, only when a bottom hold circuit (not illustrated) is provided between the first output terminal 2 and the first pulse generation circuit 17 and between the second output terminal 3 and the second pulse generation circuit 25, the exit from a defective portion is detected later than the actual time of the exit.

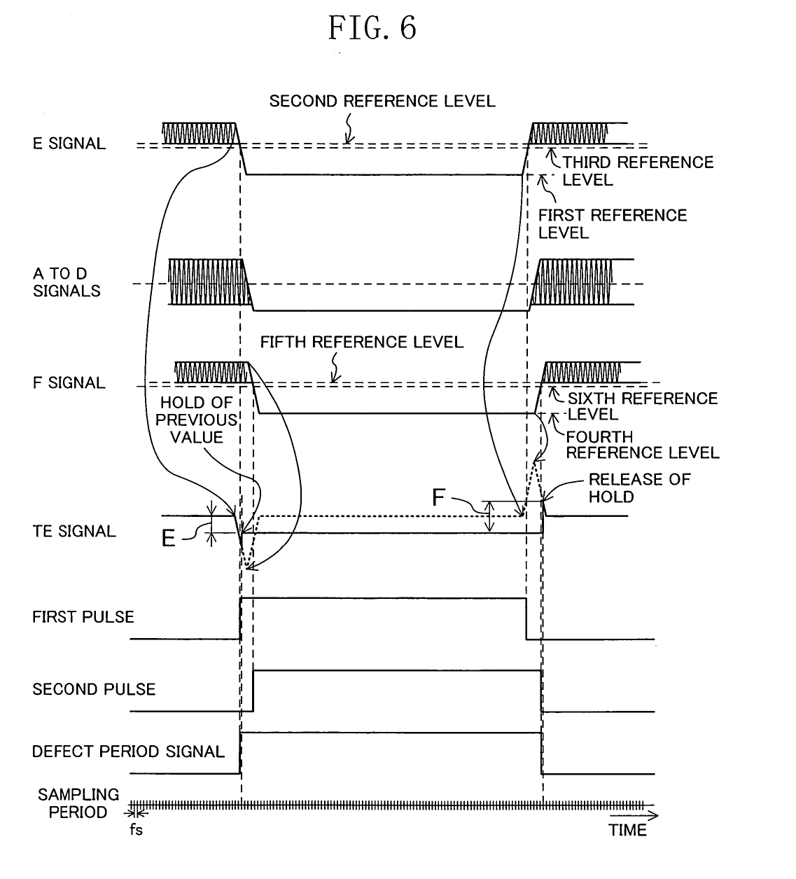

Waveforms of major parts in the thus-constructed defect period detection circuit 5 when a beam passes through a defective portion present on the optical disk 8 will be described with reference to FIG. 6.

FIG. 6 indicates an E signal caused by a preceding sub-beam, A to D signals caused by a main beam, an F signal caused by a following sub-beam, a TE signal, the first pulse from the first pulse generation circuit 17, the second pulse from the second pulse generation circuit 25, a defect period signal, and a sampling period, in this order from the top. Regarding the TE signal, a dotted line represents a waveform when hold is not performed, and a solid line represents a waveform when hold is performed.

When the preceding sub-beam enters a defective portion present on a recording surface of the optical disk 8, the E signal first starts being attenuated. When the E signal starts being attenuated, an amplitude of the TE signal starts being increased. At the time when a level of the E signal becomes lower than the third reference level, a defect period is detected based on such a change in the E signal, and the TE signal is held to a value in the previous sampling time (the previous value). For example, when a time difference between the preceding sub-beam and the main beam is two times larger than the sampling period, a defect period can be detected earlier by two sampling operations in the second embodiment than in the conventional technique for detecting a defect period using a main beam. Therefore, an amplitude E of the TE signal which is held is small, whereby tracking servo is suppressed from falling into an extraordinary operation during a defect period.

Next, in the case of exit from a defect period, the E signal exits a defective portion earlier. However, hold of the TE signal is not released until a result of detection of a defect period indicates the exit of the F signal from the defective portion. When both the E signal and the F signal exit the defective portion, the hold of the TE signal is released. Therefore, in the defect period detection circuit 5 of the second embodiment, the TE signal can be held during a period of time from the entry of the E signal into a defective portion until the exit of the F signal from the defect period.

In FIG. 6, the case where the entry and exit of the E signal into and from a defect period precede from those of the F signal, is described. According to the defect period detection circuit 5 of the second embodiment, even when the lengths of defect periods detected based on the E signal and the F signal are different from each other due to a defective portion having a shape such that a border of the defective portion is oblique with respect to a radial direction of the optical disk 8, or when the entry and exit of the F signal into and from a defect period precede those of the E signal, it is possible to correctly detect a period of time from the entry of one of a preceding sub-beam and a following sub-beam into a defective portion until the exit of both of the preceding sub-beam and the following sub-beam from the defective portion as a defect period.

### Third Embodiment

Next, an optical disk device according to a third embodiment of the present invention will be described. In the third embodiment, a variation of the defect period detection circuit will be illustrated.

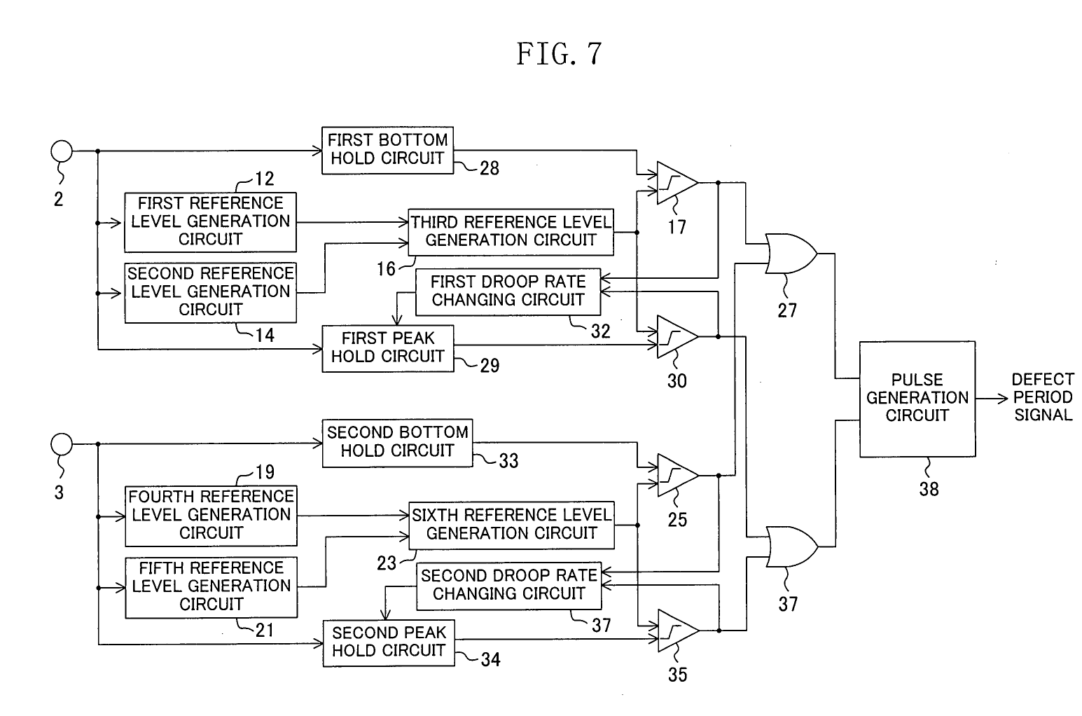

FIG. 7 illustrates a structure of a defect period detection circuit according to the third embodiment of the present invention. The same parts as those of FIG. 5 are indicated with the same reference numerals and will not be explained. The defect period detection circuit of FIG. 7 is different from that of FIG. 5 in that a peak hold circuit and a bottom hold circuit are connected between the E and F signals and a binarization circuit (pulse generation circuit) and a droop rate changing circuit is connected between outputs of the peak hold circuit and the binarization circuit.

Hereinafter, a detailed structure of the defect period detection circuit of FIG. 7 will be described. A structure involved in generation of third and sixth reference levels are the same as that of FIG. 5 and will not be explained.

The first pulse generation circuit 17 binarizes the E signal bottom-held by a first bottom hold circuit 28 connected to the first output terminal 2 using the third reference level to generate a first pulse whose rising indicates the entry of the E signal into a defect period.

Similarly, a third pulse generation circuit 30 binarizes the E signal peak-held by a first peak hold circuit 29 connected to the first output terminal 2 using the third reference level to generate a third pulse whose falling indicates the exit of the E signal from a defect period. In this case, a first droop rate changing circuit 32 increases a droop rate of the first peak hold circuit 29 connected to the first output terminal 2 using the rising of the first pulse from the first pulse generation circuit 17.

Therefore, the third pulse rises quickly after the E signal enters a defect period, so that the rising of the third pulse is secured even when the defect period is short. The first droop rate changing circuit 32 uses the rising of the third pulse from the third pulse generation circuit 30 to cause the droop rate of the first peak hold circuit 29 to quickly return to the original speed. Thereby, it is possible to stabilize a peak hold waveform after exit from a defect period.

Similarly, the second pulse generation circuit 25 binarizes the F signal bottom-held by a second bottom hold circuit 33 connected to the second output terminal 3 using the sixth reference level to generate a second pulse whose rising indicates the entry of the F signal into a defect period.

Similarly, a fourth pulse generation circuit 35 binarizes the F signal peak-held by a second peak hold circuit 34 connected to the second output terminal 3 using the sixth reference level to generate a fourth pulse whose falling indicates the exit of the F signal from a defect period. In this case, a second droop rate changing circuit 37 increases a droop rate of the second peak hold circuit 33 connected to the second output terminal 3 using the rising of the second pulse from the second pulse generation circuit 25.

Therefore, the fourth pulse rises quickly after the F signal enters a defect period, so that the rising of the fourth pulse is secured even when the defect period is short. The second droop rate changing circuit 37 uses the rising of the fourth pulse of the fourth pulse generation circuit 35 to cause a droop rate of the second peak hold circuit 33 to return to the original speed. Thereby, it is possible to stabilize a peak hold waveform after exit from a defect period.

Further, in FIG. 7, the first OR circuit 27 calculates a logical OR of an output signal of the first pulse generation circuit 17 and an output signal of the second pulse generation circuit 25 to generate a fifth pulse whose rising indicates the entry of the E signal or the F signal into a defect period.

Similarly, a second OR circuit 37 calculates a logical OR of an output signal of the third pulse generation circuit 30 and an output signal of the fourth pulse generation circuit 35 to generate a sixth pulse whose falling indicates the exit of the E signal and the F signal from a defect period.

Finally, a fifth pulse generation circuit 38 connected to an output of the first OR circuit 27 and an output of the second OR circuit 37 uses the rising of the fifth pulse and the falling of the sixth pulse to generate a detection pulse (defect period signal) indicating from the entry of the E signal or the F signal into a defect period until the exit of the E signal and the F signal from the defect period.

Therefore, by peak hold and bottom hold, chattering can be prevented. In addition, even when the lengths of defect periods detected based on the E signal and the F signal are different from each other due to a defective portion having a shape such that a border of the defective portion is oblique with respect to a radial direction of the optical disk 8, or when the entry and exit of the F signal into and from a defect period precede those of the E signal, it is possible to correctly detect a period of time from the entry of one of a preceding sub-beam and a following sub-beam into a defective portion until the exit of both of the preceding sub-beam and the following sub-beam from the defective portion as a defect period.

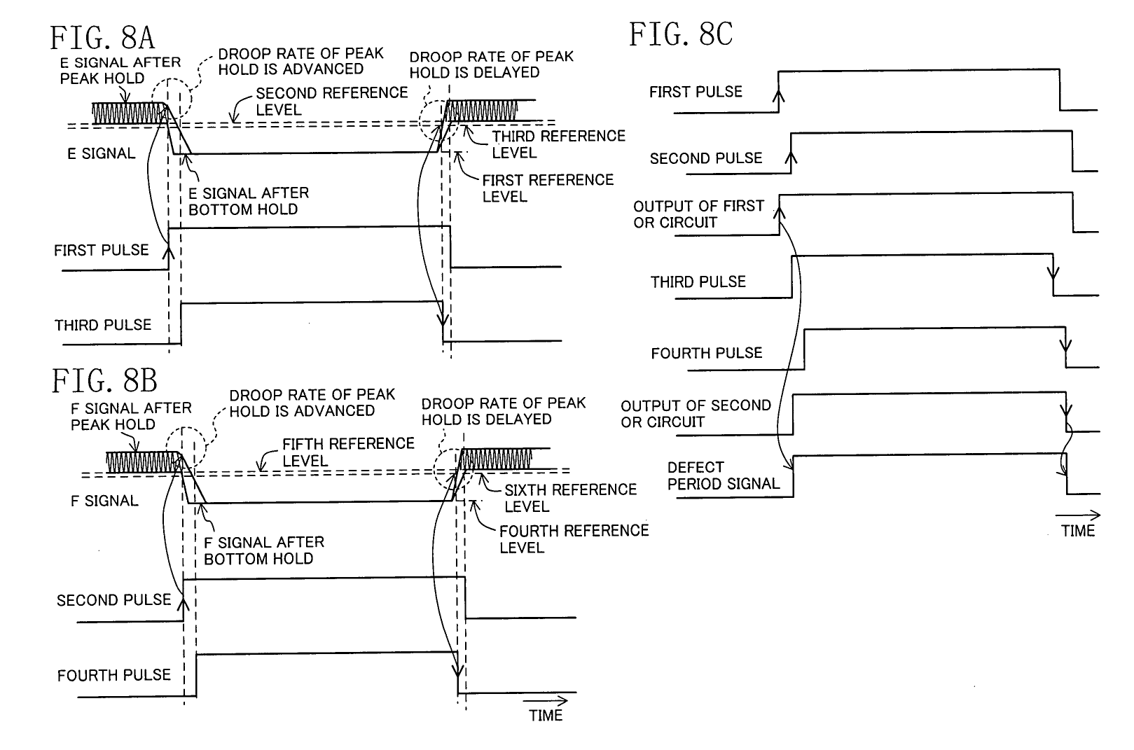

Waveforms of major parts in the thus-constructed defect period detection circuit when a beam passes through a defective portion present on the optical disk 8 will be described with reference to FIG. 8.

(a) of FIG. 8 illustrates an E signal caused by a preceding sub-beam, a first pulse from the first pulse generation circuit 17, and a third pulse from the third pulse generation circuit 30, in this order from the top. (b) of FIG. 8 illustrates an F signal caused by a following sub-beam, a second pulse from the second pulse from the second pulse generation circuit 25, and a fourth pulse from the fourth pulse generation circuit 35, in this order from the top. FIG. 8C indicates the first pulse, the second pulse, output signals of the first OR circuit 27, the third pulse, the fourth pulse, an output signal of the second OR circuit 37, and an output signal (defect period signal) of the fifth pulse generation circuit 38, in this order from the top.

Next, an operation of the third embodiment will be described. When a preceding sub-beam enters a defective portion present on a recording surface of the optical disk 8, a signal obtained by bottom-holding the E signal and a signal obtained by peak-holding the E signal first start being attenuated. The falling of the bottom hold signal is earlier than that of the peak hold signal. Therefore, at a time when a level of the signal obtained by bottom-holding the E signal becomes lower than the third reference level earlier than the peak hold signal, the first pulse of the first pulse generation circuit 17 rises. In addition, since the droop rate of the first peak hold circuit 29 is increased, the signal obtained by peak-holding the E signal falls quickly and the third pulse of the third pulse generation circuit 30 rises. In this case, the rising of the first pulse correctly indicates the entry of the E signal into a defect period, and the third pulse rises slightly later than the first pulse.

Next, when the E signal exits a defective portion, the peak hold signal rises earlier than the bottom hold signal. Therefore, at a time when a level of the signal obtained by peak-holding the E signal becomes higher than the third reference level earlier than the bottom hold signal, the third pulse of the third pulse generation circuit 30 falls. In addition, the droop rate of the first peak hold circuit 29 is delayed so that a peak hold waveform after exit from a defect period is stabilized. In this case, the falling of the third pulse correctly indicates the exit of the E signal from a defect period, and the first pulse falls slightly later than the third pulse.

Similarly, when a following sub-beam enters a defective portion present on a recording surface of the optical disk 8, a signal obtained by bottom-holding the F signal and a signal obtained by peak-holding the F signal first start being attenuated. The falling of the bottom hold signal is earlier than that of the peak hold signal. Therefore, at a time when a level of the signal obtained by bottom-holding the F signal becomes lower than the sixth reference level earlier than the peak hold signal, the second pulse of the second pulse generation circuit 25 rises. In addition, since the droop rate of the second peak pulse is increased, the signal obtained by peak-holding the F signal falls quickly and the fourth pulse of the fourth pulse generation circuit 35 rises. In this case, the rising of the second pulse correctly indicates the entry of the F signal into a defect period, and the fourth pulse rises slightly later than the second pulse.

When the F signal exits a defective portion, the peak hold signal rises earlier than the bottom hold signal. Therefore, at a time when a level of the signal obtained by peak-holding the F signal becomes higher than the sixth reference level earlier than the bottom hold signal, the fourth pulse of the fourth pulse generation circuit 35 falls. In addition, the droop rate of the second peak hold circuit 34 is delayed so that a peak hold waveform after exit from a defect period is stabilized. In this case, the falling of the fourth pulse correctly indicates the exit of the F signal from a defect period, and the second pulse falls slightly later than the second pulse.

Therefore, the rising of the output of the first OR circuit 27 correctly indicates entry into a defect period, and the falling of the output of the second OR circuit 37 correctly indicates exit from a defect period. Therefore, by detecting the rising of the output pulse of the first OR circuit 27 and the falling of the output pulse of the second OR circuit 37, a defect period signal correctly indicating a defect period is generated.

In FIG. 8, the case where the entry and exit of the E signal into and from a defect period precede from those of the F signal is described. According to the defect period detection circuit of the third embodiment, even when the lengths of defect periods detected based on the E signal and the F signal are different from each other due to a defective portion having a shape such that a border of the defective portion is oblique with respect to a radial direction of the optical disk 8, or when the entry and exit of the F signal into and from a defect period precede those of the E signal, it is possible to correctly detect a period of time from the entry of one of a preceding sub-beam and a following sub-beam into a defective portion until the exit of both of the preceding sub-beam and the following sub-beam from the defective portion as a defect period.

### Fourth Embodiment

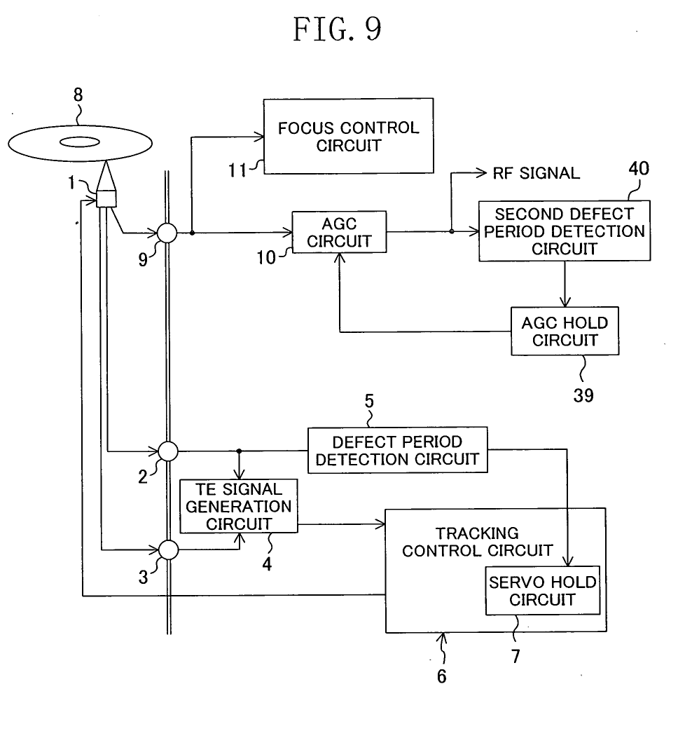

Next, an optical disk device according to a fourth embodiment of the present invention will be described with reference to FIG. 9. Note that the same parts as those of FIG. 1 are indicated with the same reference numerals and will not be explained.

The optical disk device of the fourth embodiment is different from that of the first embodiment of FIG. 1 in that a second defect period detection circuit 40 is connected to an input of the AGC hold circuit 39 instead of the defect period detection circuit 5 which employs the E signal.

The second defect period detection circuit 40 is connected to an output of the AGC circuit 10, and detects a defect period based on a level of the RF signal. For example, the second defect period detection circuit 40 detects entry into a defect period when levels of the A to D signals become lower than a reference level obtained by dividing a normalized amplitude of the AGC circuit 10 by a maximum gain of the AGC circuit 10.

Although, in the fourth embodiment, the first defect period detection circuit 5 employs only the E signal, the first defect period detection circuit 5 may employ both the E signal and the F signal as illustrated in the second embodiment.

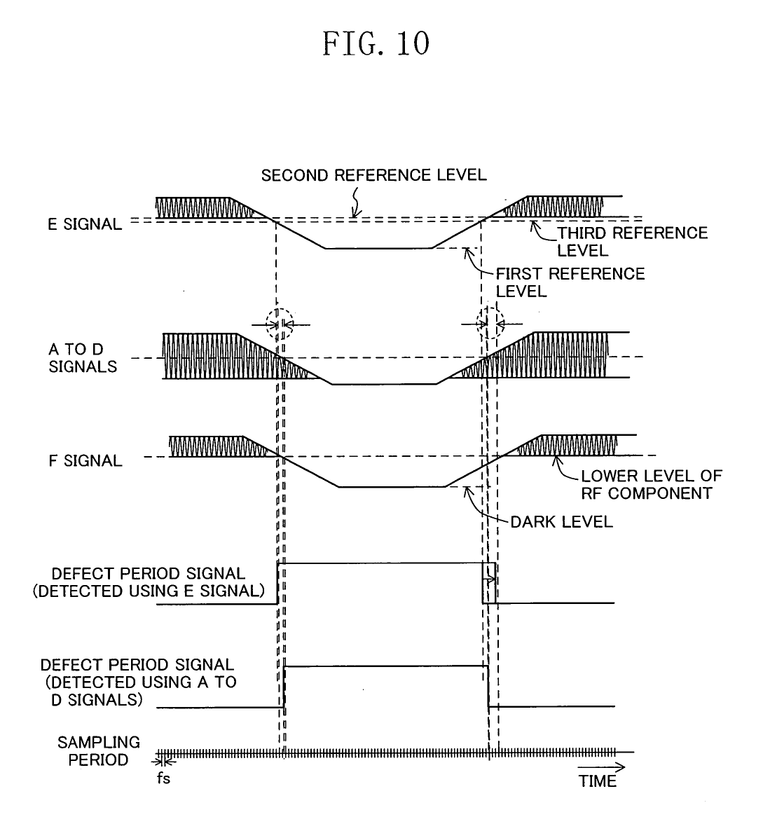

Waveforms of major parts in the thus-constructed defect period detection circuit when a beam passes through an ordinary defective portion, such as a scratch on the optical disk 8 or foreign matter attached thereon, will be described with reference to FIG. 10.

FIG. 10 indicates an E signal caused by a preceding sub-beam, A to D signals caused by a main beam, an F signal caused by a following sub-beam, a defect period signal of the first defect period detection circuit 5, a defect period signal of the second defect period detection circuit 40, and a sampling period, in this order from the top.

When the preceding sub-beam enters a defective portion present on the optical disk 8, the E signal first starts being attenuated. At a time when a level of the E signal becomes lower than the third reference level, the first defect period detection circuit 5 detects entry into a defect period based on the E signal. Next, the A to D signals are attenuated. At a time when levels of the A to D signals become lower than, for example, a reference level obtained by dividing the normalized amplitude of the AGC circuit 10 by the maximum gain of the AGC circuit 10, the second defect period detection circuit 40 detects entry into a defect period based on the A to D signals. In this case, in order to stably hold tracking servo, the first defect period detection circuit 5 detects entry into a defect period as quickly as possible, and avoids detection of exit until as late as possible. In addition, the second defect period detection circuit 40 does not detect entry into a defect period until amplitudes of the A to D signals reach minimum amplitudes which can be normalized by the AGC circuit 10, and detects exit only after the amplitudes of the A to D signals reach those which can be normalized by the AGC circuit 10. Therefore, the gain hold period of the AGC circuit 10 does not have to be longer than necessary and failure of data detection less occurs, as compared to when the first defect period detection circuit 5 is used to hold the gain of the AGC circuit 10.

Therefore, in the fourth embodiment, the gain hold period of the AGC circuit 10 during a defect period can be minimized, thereby making it possible to reduce disturbance of tracking control and minimize failure of data detection.

### Fifth Embodiment

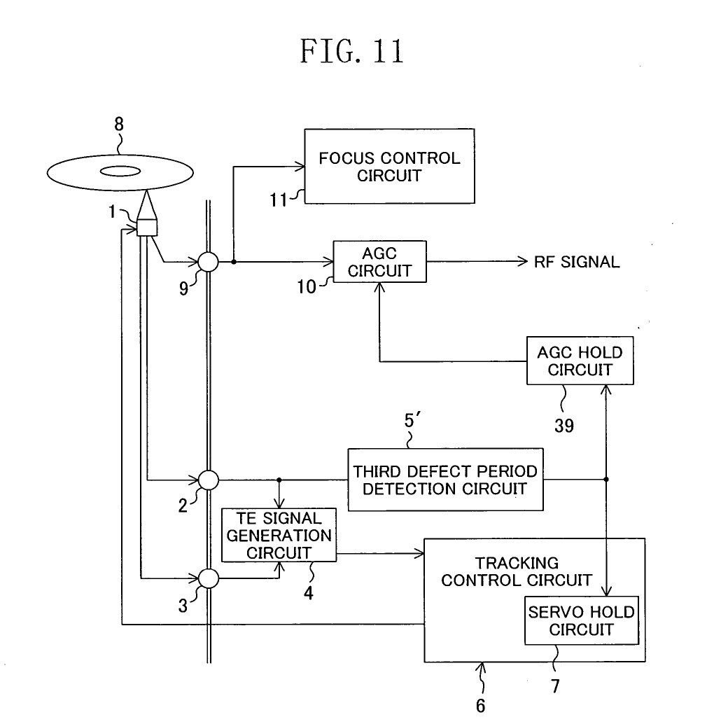

Next, an optical disk device according to a fifth embodiment of the present invention will be described with reference to FIG. 11. Note that the same parts as those of FIG. 1 are indicated with the same reference numerals and will not be explained.

The optical disk device of the fifth embodiment is different from that of the first embodiment of FIG. 1 in that a third defect period detection circuit 5′ is provided, and the third defect period detection circuit 5′ is used to generate a first defect period signal and a second defect period signal which indicates later detection of entry into a defect period than that of the first defect period signal and earlier detection of exit from the defect period than that of the first defect period signal.

Although, in the fifth embodiment, only the E signal is used for the third defect period detection circuit 5′, both the E signal and the F signal may be used as illustrated in the second embodiment.

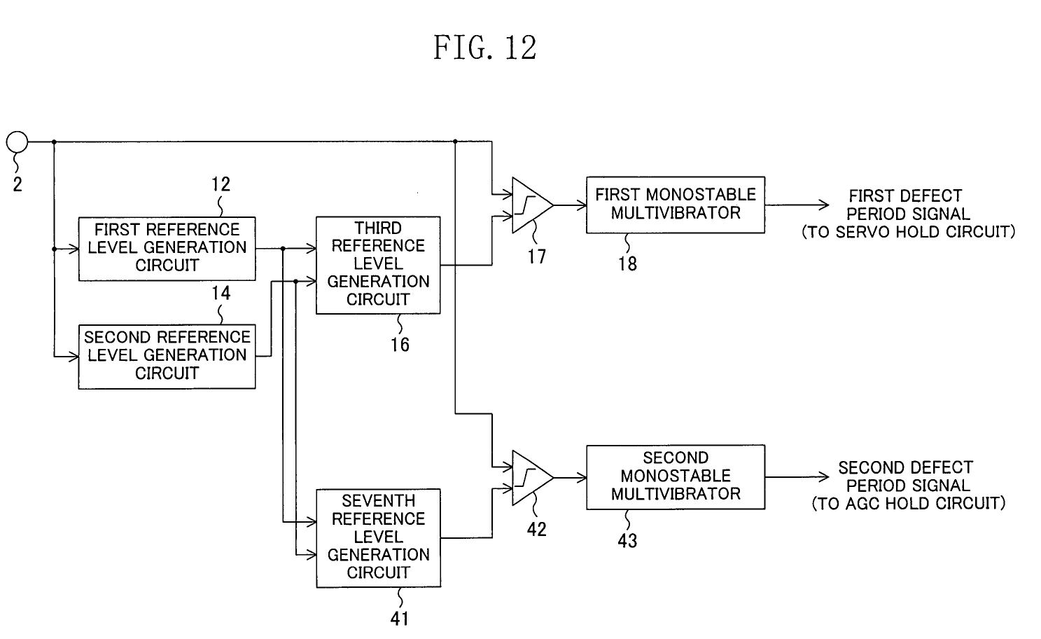

Next, a structure of the defect period detection circuit 5′ of the optical disk device according to the fifth embodiment of the present invention will be described with reference to FIG. 12.

The defect period detection circuit 5′ of the fifth embodiment is different from that of the first embodiment of FIG. 2 in that a seventh reference level generation circuit 41 and a sixth pulse generation circuit 42. The seventh reference level generation circuit 41 generates a seventh reference level having a level lower by a predetermined value than the third reference level of the third reference level generation circuit 16, based on the first reference level of the first reference level generation circuit 12 and the second reference level of the second reference level generation circuit 14. The sixth pulse generation circuit 42 is connected to an output of the seventh reference level generation circuit 41 and the first output terminal 2, and binarizes the E signal using the seventh reference level. Note that generation of the first defect period signal for holding tracking servo is carried out in the defect period detection circuit 5′ in the same manner as that of the defect period detection circuit 5 of FIG. 2 and will not be explained.

In the fifth embodiment, the third defect period detection circuit 5′ uses the seventh reference level, which is different from the third reference level, to binarize the E signal, thereby generating a second defect period signal which indicates later detection of entry into a defect period than that of the first defect period signal and earlier detection of exit from the defect period than that of the first defect period signal. Therefore, it is not necessary that the two defect period detection circuits 5 and 40 are prepared as in the fourth embodiment. In other words, an optical disk device similar to that of the fourth embodiment can be obtained using a single defect period detection circuit.

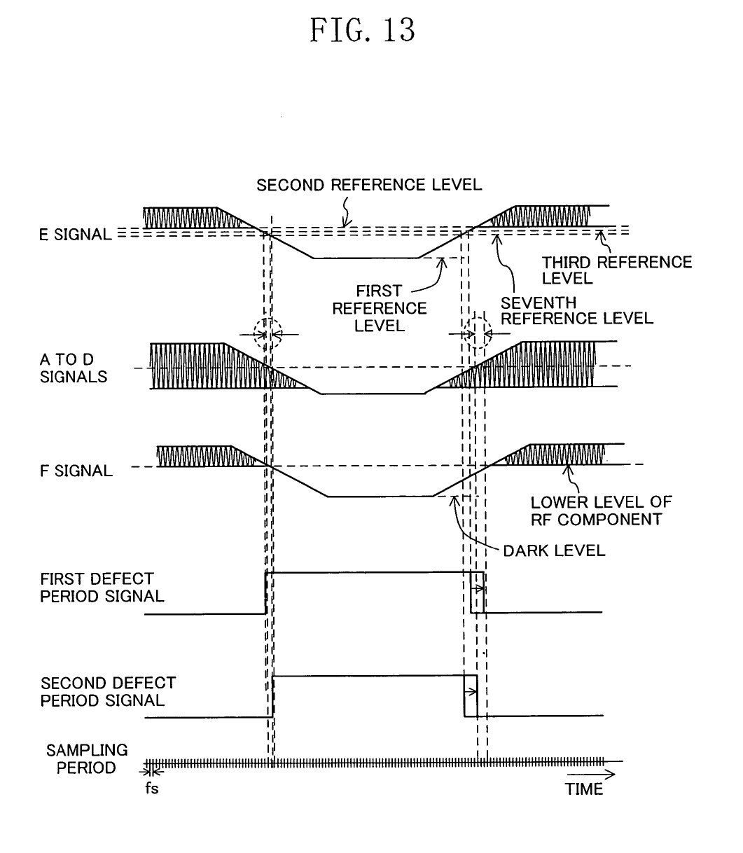

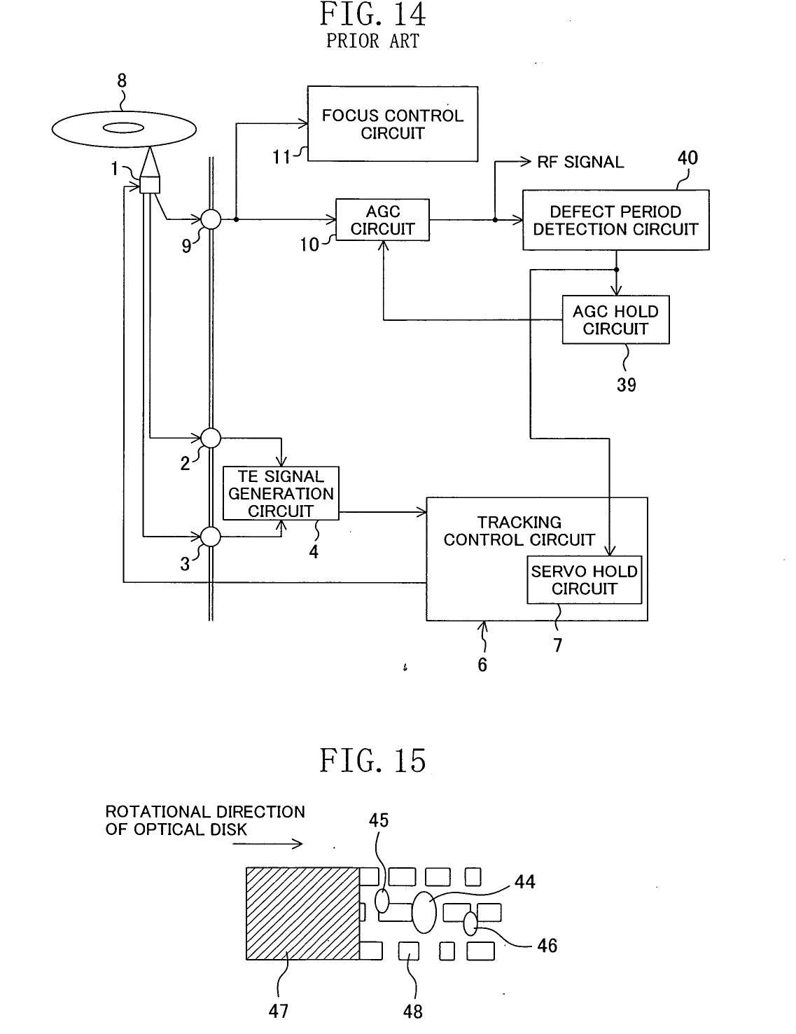

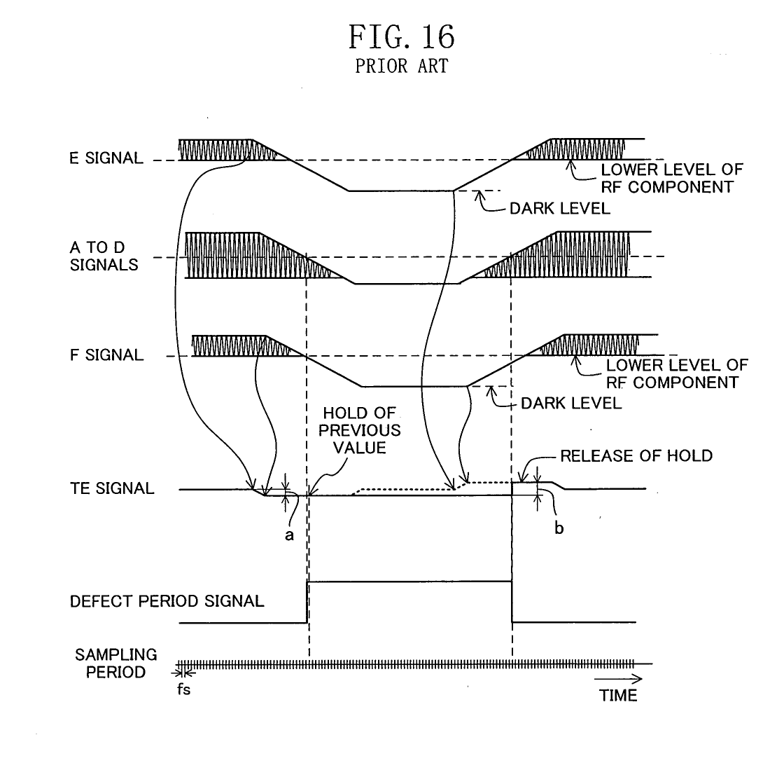

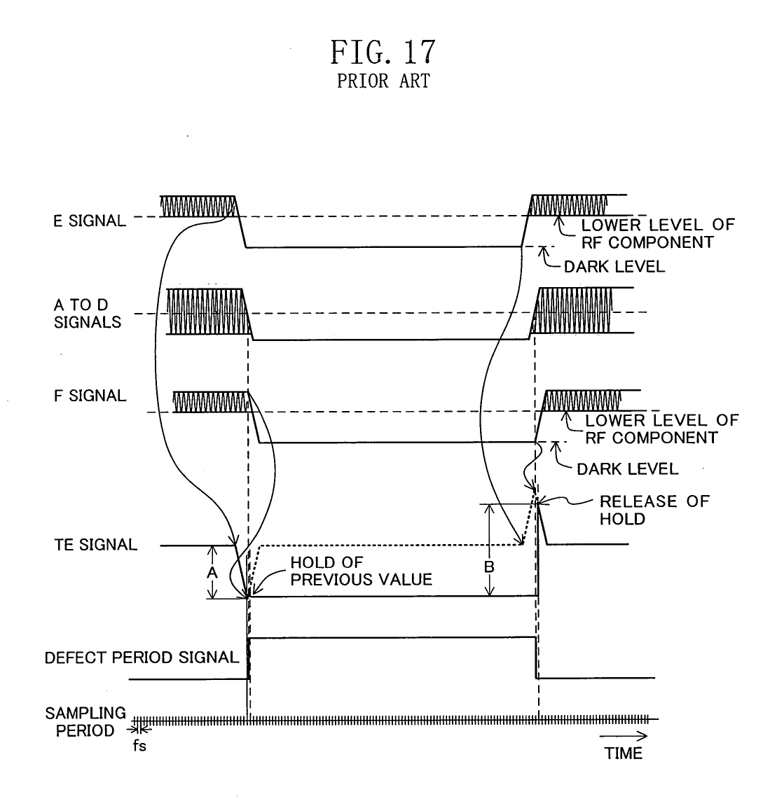

Waveforms of major parts in the thus-constructed defect period detection circuit 5′ when a beam passes through an ordinary defective portion will be described with reference to FIG. 13.

FIG. 13 indicates an E signal caused by a preceding sub-beam, A to D signals caused by a main beam, an F signal caused by a following sub-beam, a first defect period signal, a second defect period signal, and a sampling period, in this order from the top.

When the preceding sub-beam enters a defective portion present on the optical disk 8, the E signal first starts being attenuated. At a time when a level of the E signal becomes lower than the third reference level, the first defect period detection circuit 5′ outputs the first defect period signal based on the E signal. Next, when the level of the E signal becomes lower than the seventh reference level, the first defect period detection circuit 5′ outputs the second defect period signal based on the E signal.

In this case, in order to stably hold tracking servo, the first defect period signal is created so that entry is detected as quickly as possible and exit is delayed until as late as possible. In addition, the second defect period signal is created so that entry is detected later than that of the first defect period signal and exit is carried out earlier than that of the first defect period signal. Therefore, the gain hold period of the AGC circuit 10 can be shortened to a larger extent than when the gain of the AGC circuit 10 is held using the first defect period signal, and failure of data detection can be reduced.

What is claimed is:

1. An optical disk device comprising:
an optical pickup of outputting a main beam and sub-beams preceding and following the main beam onto an optical disk,
wherein, in order to reproduce information recorded on the optical disk, a digitally modulated signal and a focusing error signal are detected based on a reading spot of the main beam of the optical pickup, and a tracking error signal is detected based on reading spots of the preceding and following sub-beams of the optical pickup,
the optical disk device further comprising:
a tracking error signal generation circuit connected to a first output terminal through which a preceding sub-beam returning light signal is obtained, the preceding sub-beam returning light signal being an electrical signal obtained by converting returning light of the preceding sub-beam of the optical pickup, and a second output terminal through which a following sub-beam returning light signal is obtained, the following sub-beam returning light signal being an electrical signal obtained by converting returning light of the following sub-beam of the optical pickup, wherein the tracking error signal generation circuit generates the tracking error signal based on the preceding and following sub-beam returning light signals from the first and second output terminals;
a tracking control circuit of receiving the tracking error signal of the tracking error signal generation circuit and performing tracking control based on the tracking error signal;
a defect period detection circuit of detecting a defect period of the optical disk and outputting a defect period signal, based on the preceding sub-beam returning light signal from the first output terminal or the preceding and following sub-beam returning light signals from both the first and second output terminals; and
a hold circuit of receiving the defect period signal of the defect period detection circuit and holding the tracking control by the tracking control circuit based on the defect period signal.

2. The optical disk device of claim 1, wherein the defect period detection circuit comprises:
a first reference level generation circuit of receiving the preceding sub-beam returning light signal of the first output terminal and generating a first reference level based on a dark level of the preceding sub-beam returning light signal;
a second reference level generation circuit of receiving the preceding sub-beam returning light signal of the first output terminal and generating a second reference level using a lower level of an RF component of the preceding sub-beam returning light signal;
a third reference level generation circuit of generating a third reference level having a value between the first and second reference levels generated in the first and second reference level generation circuits;
a first pulse generation circuit of receiving the preceding sub-beam returning light signal of the first output terminal and binarizing the preceding sub-beam returning light signal with reference to the third reference level of the third reference level generation circuit to generate a first pulse; and
a monostable circuit of extending a rear edge of the first pulse generated by the first pulse generation circuit by a predetermined time to generate the defect period signal.

3. The optical disk device of claim 2, wherein the defect period detection circuit comprises:
a bottom hold circuit of bottom-holding the preceding sub-beam returning light signal, provided on a pathway through which the preceding sub-beam returning light signal is input from the first output terminal to the first pulse generation circuit.

4. The optical disk device of claim 2, wherein the defect period detection circuit comprises:
a normalization level adjustment circuit of adjusting one or both of the preceding sub-beam returning light signal and the third reference level, provided on at least one of a pathway through which the preceding sub-beam returning light signal is input from the first output terminal to the first pulse generation circuit and a pathway through which the third reference level of the third reference level generation circuit is input to the first pulse generation circuit.

5. The optical disk device of claim 1, wherein the defect period detection circuit comprises:
a first reference level generation circuit of receiving the preceding sub-beam returning light signal of the first output terminal and generating a first reference level based on a dark level of the preceding sub-beam returning light signal;
a second reference level generation circuit of receiving the preceding sub-beam returning light signal of the first output terminal and using a lower level of an RF component of the preceding sub-beam returning light signal to generate a second reference level;
a third reference level generation circuit of generating a third reference level having a value between the first and second reference levels generated in the first and second reference level generation circuits;
a first pulse generation circuit of receiving the preceding sub-beam returning light signal from the first output terminal and binarizing the preceding sub-beam returning light signal with reference to the third reference level of the third reference level generation circuit to generate a first pulse;
a fourth reference level generation circuit of receiving the following sub-beam returning light signal of the second output terminal and generating a fourth reference level based on a dark level of the following sub-beam returning light signal;
a fifth reference level generation circuit of receiving the following sub-beam returning light signal of the second output terminal and using a lower level of an RF component of the following sub-beam returning light signal to generate a fifth reference level;
a sixth reference level generation circuit of generating a sixth reference level having a value between the fourth and fifth reference levels generated in the fourth and fifth reference level generation circuits;
a second pulse generation circuit of receiving the following sub-beam returning light signal of the second output terminal and binarizing the following sub-beam returning light signal with reference to the sixth reference level of the sixth reference level generation circuit to generate a second pulse; and
a first OR circuit of receiving the first and second pulses from the first and second pulse generation circuits and calculating a logical OR of the first and second pulses.

6. The optical disk device of claim 1, wherein the defect period detection circuit comprises:
a first reference level generation circuit of receiving the preceding sub-beam returning light signal of the first output terminal and generating a first reference level based on a dark level of the preceding sub-beam returning light signal;
a second reference level generation circuit of receiving the preceding sub-beam returning light signal of the first output terminal and using a lower level of an RF component of the preceding sub-beam returning light signal to generate a second reference level;
a third reference level generation circuit of generating a third reference level having a value between the first and second reference levels generated in the first and second reference level generation circuits;
a fourth reference level generation circuit of receiving the following sub-beam returning light signal of the second output terminal and generating a fourth reference level based on a dark level of the following sub-beam returning light signal;
a fifth reference level generation circuit of receiving the following sub-beam returning light signal of the second output terminal and using a lower level of an RF component of the following sub-beam returning light signal to generate a fifth reference level;
a sixth reference level generation circuit of generating a sixth reference level having a value between the fourth and fifth reference levels generated in the fourth and fifth reference level generation circuits;
a first bottom hold circuit of outputting a lower envelope of the preceding sub-beam returning light signal of the first output terminal;
a first peak hold circuit of outputting an upper envelope of the preceding sub-beam returning light signal of the first output terminal;
a second bottom hold circuit of outputting a lower envelope of the following sub-beam returning light signal of the second output terminal;
a second peak hold circuit of outputting an upper envelope of the following sub-beam returning light signal of the second output terminal;
a first pulse generation circuit of binarizing the output signal of the first bottom hold circuit based on the third reference level of the third reference level generation circuit to generate a first pulse;
a second pulse generation circuit of binarizing the output signal of the second bottom hold circuit based on the sixth reference level of the sixth reference level generation circuit to generate a second pulse;
a third pulse generation circuit of binarizing the output signal of the first peak hold circuit based on the third reference level of the third reference level generation circuit to generate a third pulse;
a fourth pulse generation circuit of binarizing the output signal of the second peak hold circuit based on the sixth reference level of the sixth reference level generation circuit to generate a fourth pulse;
a first droop rate changing circuit of increasing a droop rate of the first peak hold circuit using rising of the first pulse of the first pulse generation circuit and decreasing the droop rate using falling of the third pulse of the third pulse generation circuit;
a second droop rate changing circuit of increasing a droop rate of the second peak hold circuit using rising of the second pulse of the second pulse generation circuit and decreasing the droop rate using falling of the fourth pulse of the fourth pulse generation circuit;
a first OR circuit of receiving the first and third pulses from the first and third pulse generation circuits and calculating a logical OR of the first and third pulses;
a second OR circuit of receiving the second and fourth pulses from the second and fourth pulse generation circuits and calculating a logical OR of the second and fourth pulses from the second and fourth pulses; and
a fifth pulse generation circuit of generating a pulse indicating a start of a defect period with rising of an output signal of the first OR circuit and a pulse indicating an exit from the defect period with falling of an output signal of the second OR circuit.

7. The optical disk device of claim 1, comprising:
an AGC circuit connected to a third output terminal through which a main beam returning light signal is obtained, the main beam returning light signal being an electrical signal obtained by converting returning light of the main beam of the optical pickup, wherein the AGC circuit generates an RF signal obtained by normalizing an amplitude of the main beam returning light signal to a predetermined value;
a second defect period detection circuit of generating a second defect period signal indicating a second defect detection period in which detection of entry into a defect period is later and detection of exit from the defect period is earlier than those of the defect period signal generated by the defect period detection circuit; and
an AGC hold circuit of fixing a gain of the AGC circuit to a predetermined value during the second defect detection period indicated by the second defect period signal of the second defect period detection circuit.

8. The optical disk device of claim 7, wherein the second defect period detection circuit receives the RF signal from the AGC circuit and generates the second defect period signal based on the RF signal.

9. An optical disk device comprising:
an optical pickup of outputting a main beam and sub-beams preceding and following the main beam onto an optical disk,
wherein, in order to reproduce information recorded on the optical disk, a digitally modulated signal and a focusing error signal are detected based on a reading spot of the main beam of the optical pickup, and a tracking error signal is detected based on reading spots of the preceding and following sub-beams of the optical pickup,
the optical disk device further comprising:
a tracking error signal generation circuit connected to a first output terminal through which a preceding sub-beam returning light signal is obtained, the preceding sub-beam returning light signal being an electrical signal obtained by converting returning light of the preceding sub-beam of the optical pickup, and a second output terminal through which a following sub-beam returning light signal is obtained, the following sub-beam returning light signal being an electrical signal obtained by converting returning light of the following sub-beam of the optical pickup, wherein the tracking error signal generation circuit generates the tracking error signal based on the preceding and following sub-beam returning light signals from the first and second output terminals;
a tracking control circuit of receiving the tracking error signal of the tracking error signal generation circuit and performing tracking control based on the tracking error signal;
a defect period detection circuit of detecting a defect period of the optical disk and outputting a first defect period signal, and a second defect period signal indicating a second defect detection period in which detection of entry into a defect period is later and detection of exit from the defect period is earlier than those of the first defect period signal, based on the preceding sub-beam returning light signal from the first output terminal or the preceding and following sub-beam returning light signals from both the first and second output terminals;
a hold circuit of receiving the first defect period signal of the defect period detection circuit and holding the tracking control by the tracking control circuit based on the first defect period signal;
an AGC circuit connected to a third output terminal through which a main beam returning light signal is obtained, the main beam returning light signal being an electrical signal obtained by converting returning light of the main beam of the optical pickup, wherein the AGC circuit generates an RF signal obtained by normalizing an amplitude of the main beam returning light signal to a predetermined value; and
an AGC hold circuit of fixing a gain of the AGC circuit to a predetermined value during the second defect detection period indicated by the second defect period signal of the defect period detection circuit.
